(19) United States
(12) Patent Application Publication
(10) Pub. No.: US 2008/0186417 A1
(43) Pub. Date: Aug. 7, 2008

(54) DISPLAY PANEL AND DISPLAY APPARATUS HAVING THE SAME

(76) Inventors: Young-Bae Jung, Hwaseong-si (KR); Kee-Han Uh, Yongin-si (KR)

Correspondence Address: F. CHAU & ASSOCIATES, LLC, 130 WOODBURY ROAD, WOODBURY, NY, 11797, US

(21) Appl. No.: 11/923,436

(22) Filed: Oct. 24, 2007

(30) Foreign Application Priority Data
Feb. 2, 2007 (KR) 2007-11190

(51) Int. Cl. G02F 1/1335

(52) U.S. Cl. 349/12

(57) ABSTRACT

A display panel includes an array substrate, an opposite substrate and a liquid crystal layer. The array substrate has a pixel part and a lower touch electrode spaced apart from the pixel part. The opposite substrate has a common electrode receiving a common voltage and an upper touch electrode spaced apart from the common electrode and overlapping the lower touch electrode. The upper touch electrode receives a touch voltage. The liquid crystal layer is interposed between the array substrate and the opposite substrate.

### CROSS-REFERENCE TO RELATED APPLICATION

This application claims priority under 35 U.S.C. §119 to Korean Patent Application No. 2007-11190 filed on Feb. 2, 2007 in the Korean Intellectual Property Office (KIPO), the disclosure of which is incorporated by reference herein in its entirety.

### BACKGROUND OF THE INVENTION

1. Technical Field

The present invention relates to a display panel, and more particularly, to a display panel having an enhanced sensing capability and a display apparatus having the display panel.

2. Discussion of the Related Art

A liquid crystal display (LCD) apparatus has become one of the most widely used flat panel displays since its light-weight, low power consumption, and low driving voltage make it suitable for use in many electronic devices. For example, the LCD apparatus is commonly found in a variety of electronic devices such as flat screen televisions, notebook computers, cellular phones, and digital cameras.

The LCD apparatus includes an LCD panel for displaying images using a light transmitting ratio of liquid crystal molecules and a backlight assembly disposed below the LCD panel to provide the LCD panel with light.

The LCD panel includes an array substrate having a signal line, a thin film transistor (TFT) and a pixel electrode, an opposite substrate facing the array substrate and having a common electrode and a liquid crystal layer interposed between the array substrate and the opposite substrate.

The LCD panel may have a touch function capable of receiving position data through an externally applied pressure. For example, when an electronic pen or a finger touches a screen of the LCD panel, the LCD panel detects a position on which the electronic pen or finger makes contact with the screen, and converts the touch position into a position control signal to be applied to a central processing unit (CPU) of a main-system. To perform the touch function, the array substrate further includes a touch electrode and a sensor wiring.

Generally, the position control signal may be generated by varying a capacitance value between the common electrode and the touch electrode due to an externally applied pressure, or by contacting the common electrode and the touch electrode with each other. However, when the position control signal is generated by the common electrode supplied with a common voltage, a sensing capability of the LCD panel to the externally applied pressure may be reduced.

Accordingly, there exists a need for enhancing a sensing capability of a display panel.

### SUMMARY OF THE INVENTION

In an exemplary embodiment of the present invention, a display panel includes an array substrate, an opposite substrate and a liquid crystal layer.

The array substrate has a pixel part and a lower touch electrode spaced apart from the pixel part. The opposite substrate has a common electrode receiving a common voltage and an upper touch electrode spaced apart from the common electrode and overlapping the lower touch electrode. The upper touch electrode receives a touch voltage. The liquid crystal layer is interposed between the array substrate and the opposite substrate.

A plurality of the lower touch electrodes is formed along a first direction and a second direction that is substantially perpendicular to the first direction in a matrix shape. The upper touch electrode includes a plurality of sub-electrode parts and a main-electrode part. The sub-electrode parts are extended along one of the first and second directions to cover the lower touch electrodes. The main-electrode part is extended along another of the first and second directions to be electrically connected to an end portion of each of the sub-electrode parts.

Each of the lower touch electrodes has a rectangular shape, of which a length of the lower touch electrode along the first direction is greater than a length of the lower touch electrode along the second direction, wherein the sub-electrode parts of the upper touch electrode are extended in the first direction, and the main-electrode part of the upper touch electrode is extended in the second direction.

The array substrate may further include a plurality of short points formed in correspondence with four edge portions of the opposite substrate to be electrically connected to the opposite substrate. The main-electrode part may be electrically connected to at least one of the short points. Here, the common electrode is electrically connected to short points that are electrically isolated from the upper touch electrode.

The upper touch electrode further includes a connection electrode part extended from a first end portion of the main-electrode part in the first direction to be electrically connected to another of the short points.

The upper touch electrode is spaced apart from the common electrode by about 4 micrometers to about 10 micrometers.

The touch voltage is substantially greater than the common voltage. The touch voltage alternates from a high level to a low level, periodically.

The high level of the touch voltage is about 10 V to about 20 V, and the low level of the touch voltage is about 0 V.

In an exemplary embodiment of the present invention, a display apparatus has a touch function. The display apparatus includes a timing controller, a gate driving section, a data driving section and a display panel. The timing controller outputs a gate control signal and a data control signal in response to an image control signal provided from an external device. The gate driving section outputs a gate signal in response to the gate control signal. The data driving section outputs a data signal in response to the data control signal.

The display panel displays an image in response to the gate signal and the data signal. The display panel includes an array substrate, an opposite substrate and a liquid crystal layer. The array substrate has a pixel part and a lower touch electrode spaced apart from the pixel part. The opposite substrate has a common electrode receiving a common voltage and an upper touch electrode spaced apart from the common electrode and overlapping the lower touch electrode. The upper touch electrode receives a touch voltage. The liquid crystal layer is interposed between the array substrate and the opposite substrate.

When the gate control signal includes a gate clock voltage to drive the gate driving section, the touch voltage may be substantially equal to the gate clock voltage.

The display apparatus includes a touch voltage-generating section that generates the touch voltage to provide the display panel with the touch voltage. Here, the touch voltage may alternate from a high level to a low level, periodically.

The array substrate further includes a sensor wiring electrically connected to the lower touch electrode to transfer a sensing signal.

The display apparatus further includes a position signal outputting section receiving the sensing signal from the sensor wiring to provide an external side of the display apparatus with a position control signal.

The array substrate further includes a gate wiring electrically connected to the pixel part in a first direction to transfer the gate signal; and a data wiring formed in a second direction crossing the first direction to be electrically connected to the pixel part, the data wiring transferring the data signal. The pixel part includes a pixel transistor electrically connected to the gate wiring and the data wiring; and a pixel electrode electrically connected to the pixel transistor.

### BRIEF DESCRIPTION OF THE DRAWINGS

The above and other features of the present invention will become more apparent by describing in detail exemplary embodiments thereof with reference to the accompanying drawings, in which:

FIG. 1 is a block diagram showing a display apparatus according to an exemplary embodiment of the present invention;

FIG. 2 is a block diagram showing a display apparatus according to an exemplary embodiment of the present invention;

FIG. 3 is a circuit diagram for describing a process of outputting a position control signal shown in FIGS. 1 and 2;

FIG. 4 is a plan view showing a relationship between a common electrode and an upper touch electrode of the display panel of FIG. 1;

FIG. 5 is a plan view showing a relationship between a common electrode and an upper touch electrode of a display panel according to an exemplary embodiment of the present invention; and

FIG. 6 is a plan view showing a relationship between a common electrode and an upper touch electrode of a display panel according to an exemplary embodiment of the present invention.

### DESCRIPTION OF EXEMPLARY EMBODIMENTS

Exemplary embodiments of the invention are described more fully hereinafter with reference to the accompanying drawings. This invention may, however, be embodied in many different forms and should not be construed as limited to the embodiments set forth herein.

It will be understood that when an element or layer is referred to as being “on,” “connected to” or “coupled to” another element or layer, it can be directly on, connected or coupled to the other element or layer or intervening elements or layers may be present.

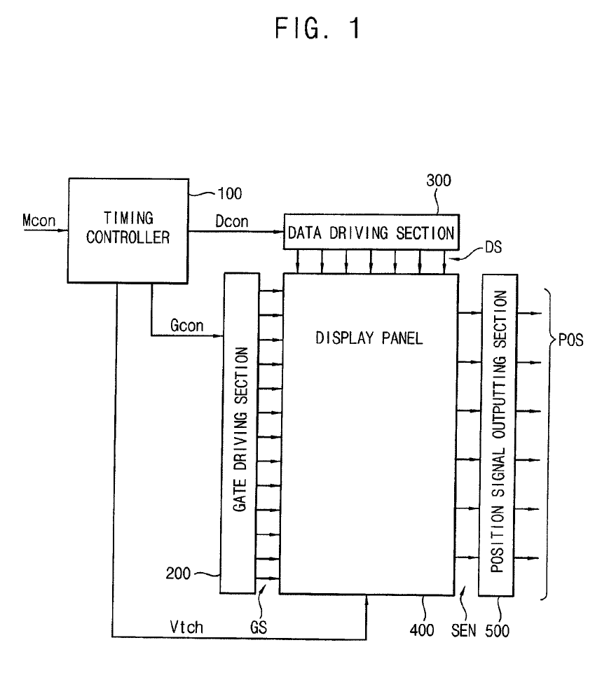

FIG. 1 is a block diagram showing a display apparatus according to an exemplary embodiment of the present invention.

Referring to FIG. 1, a display apparatus according to an exemplary embodiment of the present invention has a touch function, and includes a timing controller 100, a gate driving section 200, a data driving section 300, a display panel 400 and a position signal outputting section 500.

The timing controller 100 controls the gate driving section 200 and the data driving section 300 in response to an image control signal Mcon that is applied from an external graphic controller (not shown).

Particularly, the timing controller 100 outputs a gate control signal Gcon that controls the gate driving section 200 and a data control signal Dcon that controls the data driving section 300, in response to the image control signal Mcon. Here, the image control signal Mcon, the gate control signal Gcon and the data control signal Dcon are digital signals. The gate control signal Gcon may include a gate clock voltage for driving the gate driving section 200.

The timing controller 100 provides the display panel 400 with a touch voltage Vtch required for performing the touch function. The touch voltage Vtch may be equal to the gate clock voltage that is included in the gate control signal Gcon.

The gate driving section 200 provides the display panel 400 with a gate signal GS in response to the gate control signal Gcon. Here, the gate signal GS is an analog signal having a gate voltage for driving the display panel 400.

The data driving section 300 provides the display panel 400 with a data signal DS in response to the data control signal Dcon. Here, the data signal DS is an analog signal having a data voltage for driving the display panel 400.

The display panel 400 displays images in response to the gate signal GS and the data signal DS. The display panel 400 receives the touch voltage Vtch and various touch control signals to perform the touch function, and provides the position signal outputting section 500 with a sensing signal SEN.

The display panel 400 includes an array substrate (not shown), an opposite substrate (not shown) that faces the array substrate and a liquid crystal layer (not shown) interposed between the array substrate and the opposite substrate. Here, the gate driving section 200 may be formed on the array substrate.

The position signal outputting section 500 outputs a position control signal POS to an external side, in response to the sensing signal SEN applied from the display panel 400. For example, an external main-system (not shown) may receive the position control signal POS to perform a program according to the position control signal POS.

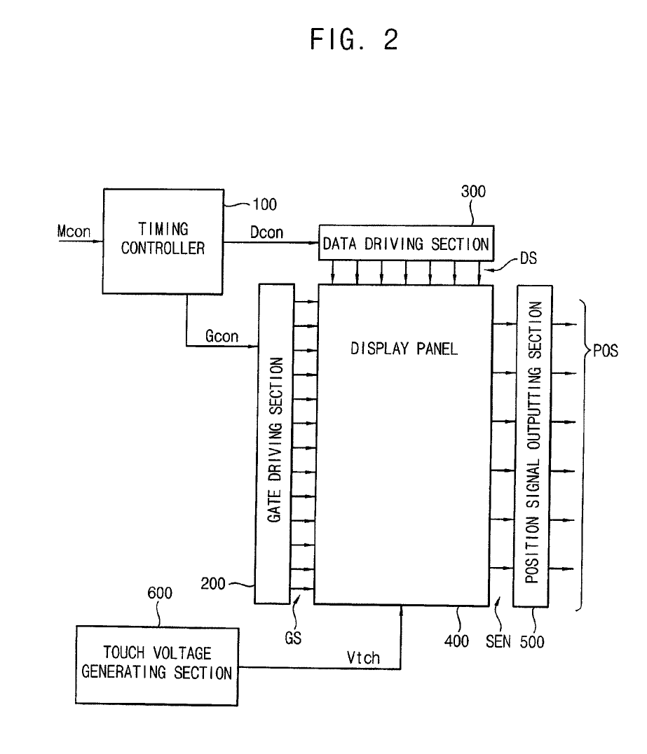

FIG. 2 is a block diagram showing a display apparatus according to an exemplary embodiment of the present invention.

Referring to FIG. 2, a display apparatus according to an exemplary embodiment of the present invention has a touch function, and includes a timing controller 100, a gate driving section 200, a data driving section 300, a display panel 400, a position signal outputting section 500 and a touch voltage-generating section 600. The display apparatus of FIG. 2 is substantially the same as the display apparatus of FIG. 1 except for at least the timing controller 100 and the touch voltage-generating section 600. Thus, identical reference numerals are used in FIG. 2 to refer to components that are the same or like those shown in FIG. 1, and thus, a detailed description thereof will be omitted.

The timing controller 100 outputs a gate control signal Gcon that controls the gate driving section 200 and a data control signal Dcon that controls the data driving section 300 in response to an image control signal Mcon that is applied from an external graphic controller (not shown).

The touch voltage-generating section 600 generates a touch voltage Vtch for performing the touch function and provides the display panel 400 with the touch voltage Vtch. The touch voltage Vtch may alternate from a high level to a low level, periodically. Here, the high level of the touch voltage Vtch may be about 10 V to about 20 V and the low level of the touch voltage Vtch may be about 0 V.

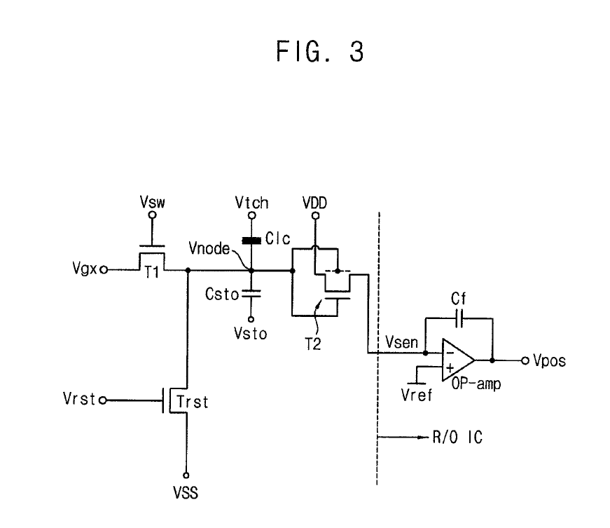

FIG. 3 is a circuit diagram for describing a process of outputting the position control signal POS shown in FIGS. 1 and 2.

Referring to FIG. 3, a display apparatus according to the present exemplary embodiment includes a first switching transistor T1, a liquid crystal capacitor Clc, a storage capacitor Csto, a second switching transistor T2, an operational amplifier OP-amp and a reset transistor Trst to realize a touch function.

The first switching transistor T1 includes a gate terminal that receives a switching voltage Vsw and a source terminal that receives a driving voltage Vgx.

A drain terminal of the first switching transistor T1 is electrically connected to a first terminal of the liquid crystal capacitor Clc and a first terminal of the storage capacitor Csto. A second terminal of the liquid crystal capacitor Clc receives the touch voltage Vtch, and a second terminal of the storage capacitor Csto receives a storage voltage Vsto.

A gate terminal of the second switching transistor T2 is electrically connected to the first terminal of the liquid crystal capacitor Clc and the first terminal of the storage capacitor Csto. A source terminal of the second switching transistor T2 receives a source voltage VDD.

A drain terminal of the second switching transistor T2 is electrically connected to a first input terminal of the operational amplifier OP-amp, and a second input terminal of the operational amplifier OP-amp receives a reference voltage Vref. Furthermore, a reference capacitor Cf may be electrically connected to the first input terminal of the operational amplifier OP-amp and an output terminal of the operational amplifier OP-amp.

The reset transistor Trst includes a gate terminal that receives a reset voltage Vrst and a source terminal that receives a synchronizing voltage VSS. Furthermore, a drain terminal of the reset transistor Trst is electrically connected to the drain terminal of the first switching transistor T1.

A driving process of the circuit shown in FIG. 3 will now be described.

When the first switching transistor T1 is turned-on by the switching voltage Vsw, the driving voltage Vgx is applied to the first terminal of the liquid crystal capacitor Clc and the first terminal of the storage capacitor Csto through a channel of the first switching transistor T1 to form a node voltage Vnode. After the node voltage Vnode is formed, the first switching transistor T1 may be turned-on.

The node voltage Vnode, which is formed in the first terminal of the liquid crystal capacitor Clc and the first terminal of the storage capacitor Csto, is changed in accordance with a change of a value of the liquid crystal capacitor Clc, and the value of the liquid crystal capacitor Clc is changed in accordance with an amount of pressure that is applied to a screen of the display panel 400.

Here, the touch voltage Vtch may have a higher level than the common voltage that is applied to the opposite substrate of the display panel 400. Accordingly, when the touch voltage Vtch has a higher level than the common voltage, a sensing capability of the display panel may be enhanced.

The touch voltage Vtch may be changed from a high level to a low level by a clock signal. Here, when the common voltage alternates from about 6 V to about 0 V, the touch voltage Vtch is alternated with a larger width than that of the common voltage. Particularly, the high level of the touch voltage Vtch may be about 10 V to about 20 V, and the low level of the touch voltage Vtch may be about 0 V.

The node voltage Vnode, which is formed in the first terminal of the liquid crystal capacitor Clc and the first terminal of the storage capacitor Csto, controls a turning-on and a turning-off of the second switching transistor T2. For example, when the second switching transistor T2 is turned-on by the node voltage Vnode, the source voltage VDD is transmitted to a channel of the second switching transistor T2 to form a sensing voltage Vsen. The sensing voltage Vsen is applied to a first input terminal of the operational amplifier OP-amp.

The operational amplifier OP-amp outputs an output voltage Vpos through its output terminal in response to the sensing voltage Vsen and the reference voltage Vref. Referring to FIGS. 1 to 3, the sensing voltage Vsen corresponds to the sensing signal SEN, and the output voltage Vpos corresponds to the position control signal POS. The operational amplifier OP-amp corresponds to the position signal outputting section 500.

When the reset transistor Trst is turned-on by the reset voltage Vrst, the synchronizing voltage VSS is applied to the first terminal of the liquid crystal capacitor Clc and the first terminal of the storage capacitor Csto through a channel of the reset transistor Trst to reset the node voltage Vnode.

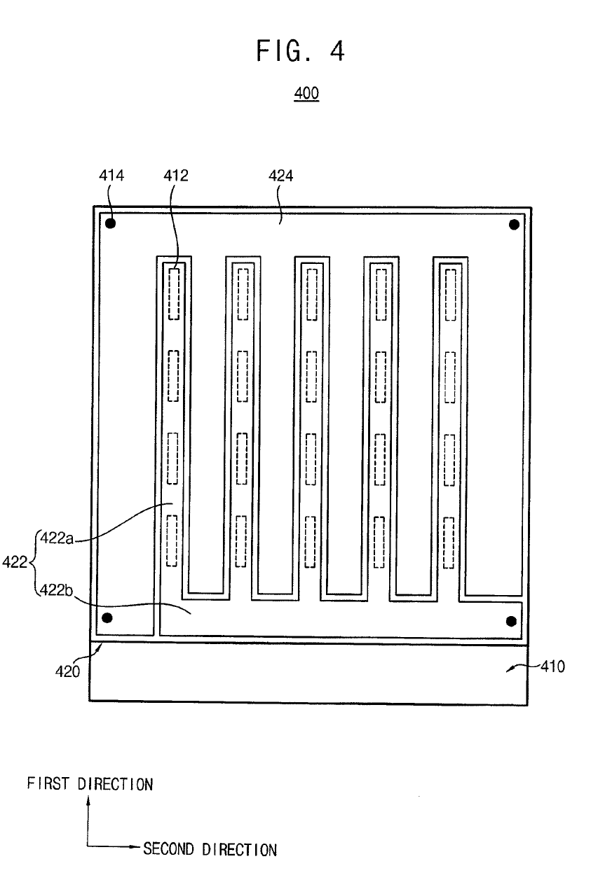

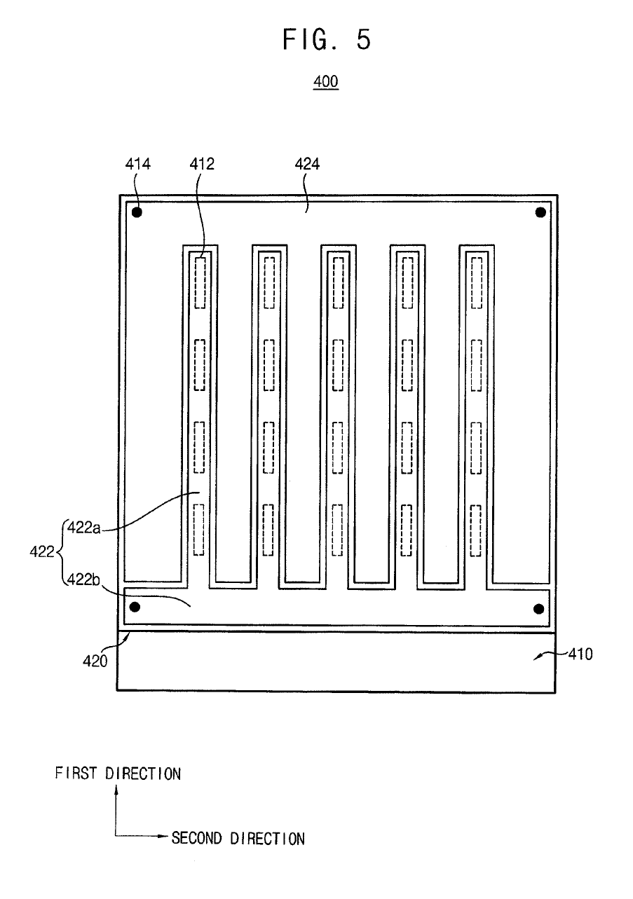

FIG. 4 is a plan view showing a relationship between a common electrode and an upper touch electrode of the display panel 400 of FIG. 1. FIG. 5 is a plan view showing a relationship between a common electrode and an upper touch electrode of a display panel according to an exemplary embodiment of the present invention.

Referring to FIGS. 1, 3, 4 and 5, a display panel 400 according to an exemplary embodiment of the present invention includes an array substrate 410, an opposite substrate 420 that faces the array substrate 410 and a liquid crystal layer (not shown) interposed between the array substrate 410 and the opposite substrate 420.

The array substrate 410 includes a gate wiring (not shown), a data wiring (not shown), a storage wiring (not shown), a pixel part (not shown), a lower touch electrode 412, a sensor wiring (not shown) and a short point 414.

A plurality of the gate wirings is formed in a first direction, and a plurality of the data wirings is formed in a second direction across the first direction. The second direction may be perpendicular to the first direction.

The pixel part (not shown) is formed within each pixel to display a unit image. The pixel part includes a pixel transistor and a pixel electrode. The pixel transistor is electrically connected to the gate wiring and data wiring. The pixel electrode is electrically connected to the pixel transistor to receive a pixel voltage from the pixel transistor. Here, the pixel electrode may include an optically transparent and electrically conductive material.

The storage wiring and the gate wiring are formed from the same layer, and the storage wiring is spaced apart from the gate wiring. The storage wiring is overlapped with the pixel electrode and the lower touch electrode 412 to receive a storage voltage Vsto from an external device. The storage wiring defines the storage capacitor Csto between the pixel electrode and the lower touch electrode 412.

The lower touch electrode 412 and the pixel electrode of the pixel part are formed from the same layer, and the lower touch electrode 412 is spaced apart from the pixel electrode. The lower touch electrode 412 may include an optically transparent and electrically conductive material which is the same as the pixel electrode.

The lower touch electrodes 412 are disposed along the first and second directions in a matrix shape. The lower touch electrode 412 may be formed in a one-to-one correspondence to the pixel part. Alternatively, the lower touch electrode 412 may be formed in correspondence with N pixel parts. Here, N is an integer. For example, one lower touch electrode 412 may be formed every four pixel parts in the first and second directions.

The lower touch electrode 412 has an extended shape that is extended along one of the first direction and the second direction. In an exemplary embodiment as shown in FIG. 4, the lower touch electrode 412 may have a rectangular shape wherein the first direction is longer than the second direction.

The sensor wiring electrically connects the lower touch electrode 412 to the operational amplifier OP-amp, so that the sensor wiring transmits the sensing voltage Vsen formed therein to the operational amplifier OP-amp.

The sensor wiring may include a first sub-sensor wiring formed along the first direction and a second sub-sensor wiring formed along the second direction. Furthermore, the lower touch electrode may include a first sub-touch electrode and a second sub-touch electrode in correspondence with the first and second sub-sensor wirings. Particularly, the first sub-sensor wiring is electrically connected to the first sub-touch electrode to transmit position information in the first direction, and the second sub-sensor wiring is electrically connected to the second sub-touch electrode to transmit position information in the second direction.

The short point 414 is formed in a plurality of positions each position corresponding to one of four corners of the opposite substrate 420. The short point 414 electrically connects the array substrate 410 to the opposite substrate 420.

The opposite substrate 420 includes, for example, a light-blocking layer (not shown), a color filter (not shown), a planarization layer (not shown), an upper touch electrode 422 and a common electrode 424.

The light-blocking layer is formed in correspondence with the gate wiring, the data wiring, and the pixel transistor to block light. The color filter is formed in correspondence with the pixel part. The planarization layer is formed on the color filter to planarize a surface of the color filter.

The upper touch electrode 422 is formed on the planarization layer to cover the lower touch electrode 412. The upper touch electrode 422 is electrically connected to at least one of the four short points 414 to receive the touch voltage Vtch.

The common electrode 424 is formed on the planarization layer to be spaced apart from the upper touch electrode 422. For example, the common electrode 424 may be formed on a portion of the planarization layer that the upper touch electrode 422 is not formed. The common electrode 424 is electrically connected to at least one of the four short points 414 that is not electrically connected to the upper touch electrode 422 to receive the common voltage.

The common electrode 424 may be spaced apart from the upper touch electrode 422 by an interval of no less than 4 micrometers to reduce the effect of the common voltage on the touch voltage Vtch supplied to the upper touch electrode 422. For example, the common electrode 424 is spaced apart from the upper touch electrode 422 by an interval of 4 micrometers to about 10 micrometers.

The upper touch electrode 422 and the common electrode 424 include an optically transparent and electrically conductive material which is the same as the pixel electrode.

Referring again to FIG. 4, the upper touch electrode 422 will now be described in detail.

The upper touch electrode 422 may include a plurality of sub-electrode parts 422a and a main-electrode part 422b.

The sub-electrode parts 422a are extended along one of the first and second directions to cover the lower touch electrodes 412. For example, when each of the lower touch electrodes has a rectangular shape wherein the first direction is longer than the second direction, each of the sub-electrode parts 422a is extended along the first direction to cover the lower touch electrodes 412 that are arranged along the first direction. Here, the sub-electrode parts 422a may have a larger width than that of the lower touch electrodes 412 to fully cover the lower touch electrodes 412.

The main-electrode part 422b is extended along another of the first and second directions to be electrically connected to an end portion of the sub-electrode parts 422a. For example, when the sub-electrode parts 422a have an extended shape that is extended along the first direction, the main-electrode 422b may have an extended shape that is extended along the second direction.

The main-electrode part 422b may be electrically connected to one of the four short points 414. In other words, an end portion of the main-electrode part 422b may be electrically connected to one of the short points 414. Alternatively, referring to FIG. 5, two end portions of the main-electrode part 422b may be electrically connected to a pair of short points among the four short points 414, which are facing each other.

Accordingly, the main-electrode part 422b is electrically connected to a portion of the short points 414 to receive the touch voltage Vtch from the portion of the short points 414. As a result, the touch voltage Vtch is also supplied to the sub-electrode parts 422a. The sub-electrode part 422a and the lower touch electrodes 412 define the liquid crystal capacitor Ccl.

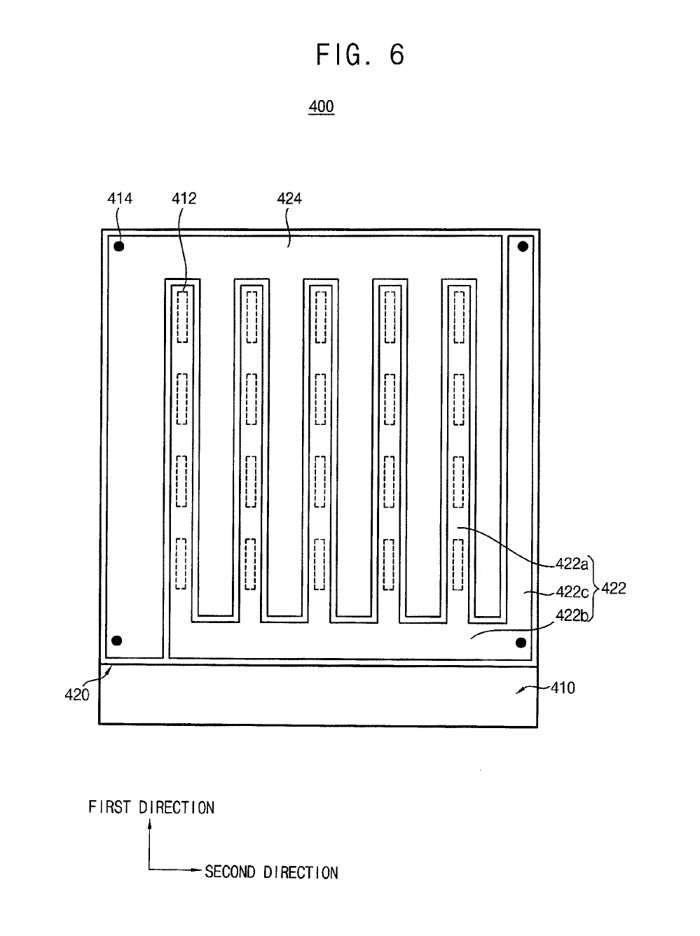

FIG. 6 is a plan view showing a relationship between a common electrode and an upper touch electrode of a display panel according to an exemplary embodiment of the present invention.

Referring to FIGS. 1, 3 and 6, a display panel 400 according to an exemplary embodiment of the present invention includes an array substrate 410, an opposite substrate 420 and a liquid crystal layer (not shown). The display panel 400 is substantially the same as the display panels 400 of FIGS. 4 and 5 except for at least an upper touch electrode 422 of the opposite substrate 420. Thus, identical reference numerals are used in FIG. 6 to refer to components that are the same or like those shown in FIGS. 4 and 5, and thus, a detailed description thereof will be omitted.

The upper touch electrode 422 is formed on the planarization layer to cover the lower touch electrode 412. The upper touch electrode 422 is electrically connected to at least one of the four short points 414 to receive the touch voltage Vtch. The upper touch electrode 422 may be spaced apart from the common electrode 424 by an interval of no less than 4 micrometers to reduce the effect of the common voltage on the touch voltage Vtch. The upper touch electrode 422 and the common electrode 424 include an optically transparent and electrically conductive material which is the same as the pixel electrode.

Particularly, the upper touch electrode 422 includes a plurality of sub-electrode parts 422a, a main-electrode part 422b and a connection electrode part 422c.

The sub-electrode parts 422a are extended along one of the first and second directions to cover the lower touch electrodes 412. For example, when each of the lower touch electrodes has a rectangular shape wherein the first direction is longer than the second direction, each of the sub-electrode parts 422a is extended along the first direction to cover the lower touch electrodes 412 that are arranged along the first direction. Here, the sub-electrode parts 422a may have a larger width than that of the lower touch electrodes 412 to fully cover the lower touch electrodes 412.

The main-electrode part 422b is extended along another of the first and second directions to be electrically connected to an end portion of the sub-electrode parts 422a. For example, when the sub-electrode parts 422a have an extended shape that is extended along the first direction, the main-electrode 422b may have an extended shape that is extended along the second direction.

The main-electrode part 422b may be electrically connected to one or two of the four short points 414. In FIG. 6, an end portion of the main-electrode part 422b is electrically connected to at least one of the four short points 414.

The connection electrode part 422c is extended from an end portion of the main-electrode part 422b in parallel with the sub-electrode part 422a. For example, the connection electrode part 422c is extended from an end portion of the main-electrode part in the first direction and is electrically connected to another of the short points 414.

In the aforementioned exemplary embodiments, although the upper touch electrode 422 was described with reference to FIGS. 4 to 6 the invention is not limited to the illustrated examples. For example, the upper touch electrode 422 may have various other shapes on condition that the upper touch electrode 422 is spaced apart from the common electrode 424 to cover the lower touch electrodes 412.

According to the aforementioned exemplary embodiments, since the upper touch electrode 422 is spaced apart from the common electrode 424, and the upper touch electrode 422 and the lower touch electrode 412 form the liquid crystal capacitor Clc to receive the touch voltage Vtch that is different from the common voltage, a sensing capability of the display panel 400 may be enhanced. In particular, when the touch voltage Vtch is greater than the common voltage, the sensing capability of the display panel 400 may be more enhanced than when the touch voltage Vtch is not greater than the common voltage.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A display panel comprising:
an array substrate having a pixel part and a lower touch electrode spaced apart from the pixel part;
an opposite substrate having a common electrode receiving a common voltage and an upper touch electrode spaced apart from the common electrode and overlapping the lower touch electrode, the upper touch electrode receiving a touch voltage; and
a liquid crystal layer interposed between the array substrate and the opposite substrate.

2. The display panel of claim 1, wherein the lower touch electrodes are arranged in a first direction and a second direction that is substantially perpendicular to the first direction in a matrix shape.

3. The display panel of claim 2, wherein the upper touch electrode comprises:
a plurality of sub-electrode parts extended along one of the first and second directions to cover the lower touch electrodes; and
a main-electrode part extended along another of the first and second directions to be electrically connected to an end portion of each of the sub-electrode parts.

4. The display panel of claim 3, wherein each of the lower touch electrodes has a rectangular shape, of which a length of the lower touch electrode along the first direction is greater than a length of the lower touch electrode along the second direction,
wherein the sub-electrode parts of the upper touch electrode are extended in the first direction, and the main-electrode part of the upper touch electrode is extended in the second direction.

5. The display panel of claim 4, wherein the array substrate further comprises a plurality of short points formed in correspondence with four edge portions of the opposite substrate to be electrically connected to the opposite substrate.

6. The display panel of claim 5, wherein the main-electrode part is electrically connected to at least one of the short points.

7. The display panel of claim 6, wherein the upper touch electrode further comprises a connection electrode part extended from a first end portion of the main-electrode part in the first direction to be electrically connected to another of the short points.

8. The display panel of claim 6, wherein the common electrode is electrically connected to short points that are electrically isolated from the upper touch electrode.

9. The display panel of claim 1, wherein the upper touch electrode is spaced apart from the common electrode by about 4 micrometers to about 10 micrometers.

10. The display panel of claim 1, wherein the touch voltage is substantially greater than the common voltage.

11. The display panel of claim 10, wherein the touch voltage alternates from a high level to a low level, periodically.

12. The display panel of claim 11, wherein the high level of the touch voltage is about 10 V to about 20 V, and the low level of the touch voltage is about 0 V.

13. A display apparatus having a touch function, the display apparatus comprising:
a timing controller outputting a gate control signal and a data control signal in response to an image control signal provided from an external device;
a gate driving section outputting a gate signal in response to the gate control signal;
a data driving section outputting a data signal in response to the data control signal; and
a display panel displaying an image in response to the gate signal and the data signal, wherein the display panel comprises,
an array substrate having a pixel part and a lower touch electrode spaced apart from the pixel part;
an opposite substrate having a common electrode receiving a common voltage and an upper touch electrode spaced apart from the common electrode and overlapping the lower touch electrode, the upper touch electrode receiving a touch voltage; and
a liquid crystal layer interposed between the array substrate and the opposite substrate.

14. The display apparatus of claim 13, wherein the gate control signal comprises a gate clock voltage to drive the gate driving section,
wherein the touch voltage is substantially equal to the gate clock voltage.

15. The display apparatus of claim 13, further comprising:
a touch voltage-generating section generating the touch voltage to provide the display panel with the touch voltage.

16. The display apparatus of claim 15, wherein the touch voltage alternates from a high level to a low level, periodically.

17. The display apparatus of claim 13, wherein the array substrate further comprises a sensor wiring electrically connected to the lower touch electrode to transfer a sensing signal.

18. The display apparatus of claim 17, further comprising:
a position signal outputting section receiving the sensing signal from the sensor wiring to provide an external side of the display apparatus with a position control signal.

19. The display apparatus of claim 13, wherein the array substrate further comprises,
a gate wiring electrically connected to the pixel part in a first direction to transfer the gate signal; and
a data wiring formed in a second direction crossing the first direction to be electrically connected to the pixel part, the data wiring transferring the data signal.

20. The display apparatus of claim 19, wherein the pixel part comprises,
a pixel transistor electrically connected to the gate wiring and the data wiring; and
a pixel electrode electrically connected to the pixel transistor.
